(19) United States
(12) Patent Application Publication
(10) Pub. No.: US 2009/0070151 A1
(43) Pub. Date: Mar. 12, 2009

(54) Advanced integrated data environment

(76) Inventor: Randi Sellari, Bryn Mawr, PA (US)

Correspondence Address: REED SMITH LLP, 2500 ONE LIBERTY PLACE, 1650 MARKET STREET, PHILADELPHIA, PA, 19103, US

(21) Appl. No.: 12/079,061

(22) Filed: Mar. 20, 2008

Related U.S. Application Data
(60) Provisional application No. 60/919,523, filed on Mar. 21, 2007.

(51) Int. Cl. G06Q 40/00; G06Q 50/00

(52) U.S. Cl. 705/4; 705/36 R

(57) ABSTRACT

The present invention is directed towards a computer software package for managing data related to the purchase of a future value asset. The invention includes a database of data related to at least one account identifying a transaction between a holder of a future value asset and a purchaser of future value assets. The data includes information regarding the transaction. The invention further includes an interface that allows access to the data and a generator for producing a report of an account.

### CROSS REFERENCE

The present application claims priority to Provisional Application No. 60/919,523, filed Mar. 21, 2007, the entire contents of which are incorporated herein by reference, including any references cited therein.

### FIELD OF THE INVENTION

The invention relates to software packages that manage data, and, more particularly, to software packages that manage data related to the purchase of future value assets.

### BACKGROUND OF THE INVENTION

A weakness in many conventional software packages that manage data is the lack of complete integration of all parts of the database. This weakness is particularly evident in the field of purchases of future value assets.

Thus, a need exists for a software package that completely integrates all parts of a database related to the purchase of future value assets.

### SUMMARY OF THE INVENTION

The invention is directed towards a computer software package for managing data related to at least one purchase of at least one future value asset. The invention comprises: a database, wherein the database comprises data related to at least one account, the account identifying a transaction between a holder of a future value asset and a purchaser of future value assets; an interface, wherein the interface allows access to the data; and a generator, wherein the generator produces at least one report of the at least one account, and the report is generated in response to at least one command entered at the interface; wherein the data comprises information regarding the transaction.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates a screen shot representative of the “Advanced Integrated Data Environment (AIDE)” and a sales home page screen;

FIG. 2 illustrates a screen shot representative of a “CPA Double Option Insurance” data table;

FIG. 3 illustrates a screen shot representative of a “Sales Highlights” queue group screen;

FIG. 4 illustrates a screen shot representative of an “Amendment Pool” data viewing and entry screen;

FIG. 5 illustrates a screen shot representative of a “People: Main Details” data viewing and entry screen;

FIG. 6 illustrates a screen shot representative of a “Sales Recently Funded” data table;

FIG. 7 illustrates a screen shot representative of an “Underwriting Status Breakdown (Total)” data table;

FIG. 8 illustrates a screen shot representative of a “Customer Service” pull-down menu and data table;

FIG. 9 illustrates a screen shot representative of a “AIDE Tasks” data viewing and entry screen;

FIG. 10 illustrates a screen shot representative of a “Search Results” data table;

FIG. 11 illustrates a screen shot representative of an “SSC: Account Details” pull-down menu;

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in software packages that manage data. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The Advanced Integrated Data Environment (AIDE) software system includes application software architecture, which may be managed by a central server. Software architecture may include a software framework that optimizes ease of use of at least one existing software platform, and that may extend the capabilities of at least one existing software platform. The application architecture may approximate the actual way that users organize and manage digital media files, and thus may organize use activities in a natural, coherent manner while delivering use activities through a simple, consistent, and intuitive interface within each application and across applications. The architecture may be reusable, providing plug-in capability to any number of applications, without extensive re-programming, which may enable parties outside of the system to create components that plug into the architecture. Thus, software or portals in the architecture may be extendable and new software or portals may be created for the architecture by any party.

The AIDE software architecture may provide, for example, applications accessible to one or more users to perform one or more functions. Such applications may be available at the same location as the user, or at a location remote from the user. Each application may provide a graphical user interface (GUI) for ease of interaction by the user with information resident in system. A GUI may be specific to a user, set of users, or type of user, or it may be the same for all users or a selected subset of users. The software architecture may provide a master GUI set that allows a user to select or interact with GUIs of one or more other applications, or that allows a user to simultaneously access a variety of information otherwise available through any portion of the system.

The AIDE software architecture may include a portal that provides, via the GUI, remote access to and from the present invention. The software architecture may include, for example, a network browser, as well as a media player. The software architecture may include the ability, either automatically based upon a user request in another application, or by a user request, to “hook”, search, or otherwise retrieve particular data from one or more remote points, such as on the internet. The software architecture may vary by user type, or it may be available to only certain user types, depending on the needs of the system. Users may have some portions, or all of software architecture, resident on uploading stations or end-user devices, or they may have linking mechanisms, as understood by those skilled in the art, to link uploading stations or end-user devices to a software architecture running on a central server via a wide area network. As such, any device having, or having access to, the software architecture may be capable of uploading, or downloading, informational files to be associated with the accounts.

Presentation of data through the software architecture may be in any sort and number of selectable formats. For example, a multi-layer format may be used, wherein additional information is available by viewing successively lower layers of presented information. Such layers may be made available by the use of drop-down menus, tabbed pseudo-manila folder files, or other layering techniques understood by those skilled in the art. Formats may include AutoFill functionality, wherein data may be filled responsively to the entry of partial data in a particular field by the user. All formats may be in standard readable formats, such as XML.

The visual interface may be rendered by any computer code and/or programs necessary and as may be understood by those of ordinary skill in art. The visual interface may have many functions, such as present information in many forms to users, act as a conduit for users and administrators to enter information into the system, display user choices for selection, graphs, photographs, pictures, drawings, charts, and/or animated content, for example. Additionally, the visual interface may be used in conjunction with audio cues or commands, provided that the device used supports play of such audio files. In one embodiment, the visual interface may be a secured interface, such that users must log on to such an interface through a secure portal. This may require users to have an account, which may include a log-on identity and password, for example, as may be understood by those of ordinary skill in the art. If the user is not an allowed user or registered user and/or not an administrator, the user may be prevented from accessing any further information. If the user is an allowed user and/or system administrator, then the user/administrator may access further information. Such security features of the visual interface may exist at any level of security, ranging from, for example, very restrictive of entry to the website to no restriction of entry to the website, as a user may choose or the administrator may desire and may be changed over time as the administrator and/or user sees the need.

The AIDE advanced integrated data environment may facilitate handling of all transactions and customer-related data for a company, the main business of which may be the purchase of future value assets from a holder of a future value asset that may desire a lump-sum payment. A future value asset is an asset for which the holder is scheduled to receive future payment. Examples of future value assets include structured settlements, annuities, life insurance payouts, lawsuit advances, mortgage notes, inheritance advances, lottery payouts, and cell tower lease advances. A transaction may be a sale or a potential sale of a future value asset.

The system may allow a company's sales force to store and access all sales and customer-related data of the business. Data related to asset purchase agents may be stored in the system, and the asset purchase agents may be grouped into groups, and individual asset purchase agents may be linked to client contact or client account records. The system may allow a sales force to store all information related to obtaining clients, such as through promotion and advertising efforts. Asset purchase agents may use the system to enter information about new or prospective clients into the system, and asset purchase agents may query the system to provide appropriate client information for follow-up phone calls.

Asset purchase agents may use the system to provide reminders when progressing a customer account through each step of the process, such as from initial contact, including filling out appropriate paperwork, sending forms back and forth between the company and a client's attorney, filing forms with the client's local court system, disbursing money to the client, and receiving money from the source of the future value asset. The system may categorize accounts into categories to facilitate the above process whereby the asset purchase agents take each step along the path from initial contact to the company receiving money.

The system may assist underwriting employees during the underwriting process. Underwriting data may be entered into the system, including information about the reliability of the source of funds. The system may keep track of all of the underwriting documents that are passed between the client, the sales force, the underwriting employees, the company's attorneys, the client's attorneys, and the client's local court system.

The system may assist the company's attorneys in tracking of data related to clients' involvement with their local court system, including documents related to assigning all or part of a structured settlement to the company in return for a lump sum cash payment. The system may house contact data for all of the company's and clients' attorneys, clients' insurance companies that may be obligated to pay a structured settlement to a client, and contacts at the client's local court system.

The system may assist the company's customer service employees to keep track of data related to serving clients. Clients may borrow money against the value of their future value asset, and customer service representatives may interact with customers to collect payments of principal and interest on a related loan. The system may keep track of data related to escrow accounts that are required in order to satisfy legal requirements governing the assignment of a structured settlement. Customer service employees may use the system to provide reminders regarding delinquent customer accounts and classification into various types of collection status.

The system may assist a company's accounting employees in keeping track of all money passing between the company, clients, the court systems, insurance companies that may be responsible for payment of the structured settlement, and banks that may assist with the process of lending money to clients or investing the company's assets. The system may assist accounting employees generate various monetary reports to remain apprised of the financial health of the company, and to comply with state, federal, and court-mandated accounting reporting requirements.

The system may assist information technology employees keep the system running properly. IT employees may need to establish accounts for sales representatives, company attorneys, accounting employees, customers, insurance companies, and opposing counsel. IT employees may need to group various screens such that certain groups of employees may only access information that may be required in performing their jobs. Other information may be treated in the system with restricted access, so as to protect the confidential information of the company and its clients. The system may assist IT employees help other company employees learn how to use the system, via a help desk and help ticket by prompting IT employees to solve system problems, such that an efficient priority order is followed.

The system may employ multiple mechanisms of searching component databases so employees in sales, legal, accounting, underwriting, customer service, or IT may quickly retrieve customer account information or other data from the system, in order to fulfill job responsibilities more efficiently.

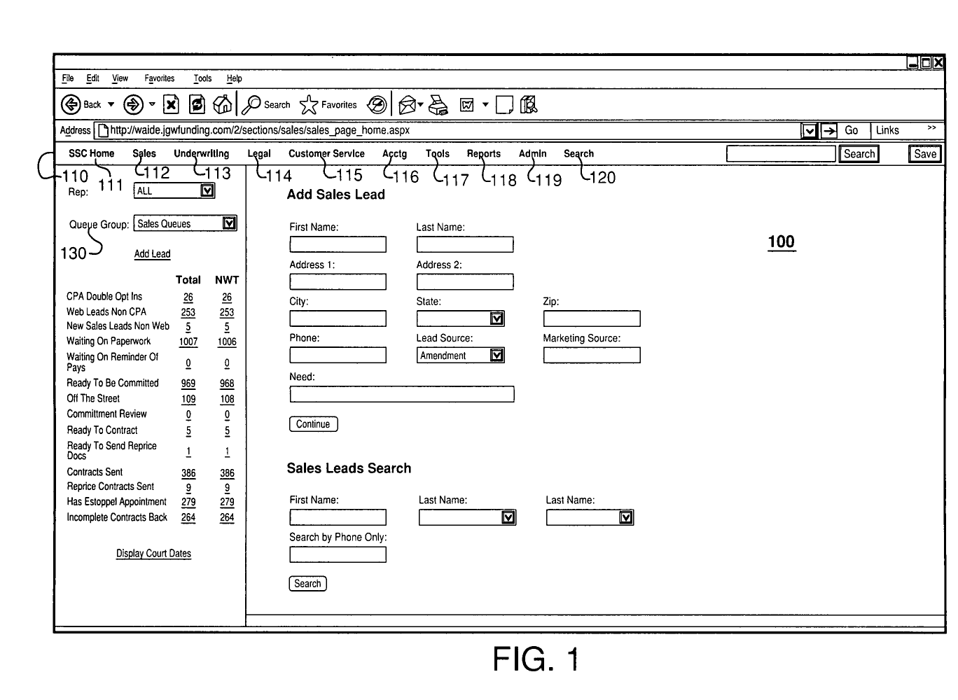

Referring now to FIG. 1, there is shown a screen shot of the Advanced Integrated Data Environment (AIDE) 100. There may be many pull down menus 110 that are accessible from the initial screen. As may be seen in FIG. 1, the menu options may include SSC Home 111, Sales 112, Underwriting 113, Legal 114, CustomerService 115, Accounting 116, Tools 117, Reports 118, Admin 119, and Search 120. Also, there may be a search field that permits user input with a search button, and there may be a save button. A user may input a client name for example and depress the search button, instructing the software to query for the client name and return entries including the client name.

The Sales pull-down menu 112 may include the options (described below) of Sales Home Page, Sales Pools, Web Leads, and Recently Funded. There may be sub-menus accessible by floating the mouse over any of the primary menu selections. Sales Pools may have a sub-menu that leads to the options (described below) of amendment pool, prospect pool, web leads pool, and future prospects pool.

FIG. 1 shows the “Sales Home” screen, which may serve as a portal from which asset purchase agents or other users may access prospective client or other sales records. A user may access the Sales Home screen via the pull-down menu. As may be seen in FIG. 1, the user may add a sales lead by entering data including data fields such as first name, last name, address line 1, address line 2, city, state, zip code, phone, lead source which is the source of the sales lead, marketing source, and need, for example. There may be a field or fields for sales leads searching that allows a search for individual sales leads. Search fields may include first name, last name, state, and search by phone. There may be a search button which initiates the search. Any of the fields shown in FIG. 1 may include a pull down menu that allows the user to select from a list of predefined options, or it may be a text entry box where the user may input information. The sales home screen may include choices for a representative that may have a pull down menu where the user may select the name of a sales representative in order to access sales information related to that specific sales representative. The screen of FIG. 1 may include a Queue Group option, which may be in the form of a pull-down menu, to allow the user to view sales records according to a desired data category. There may be text “ad lead” that may be selected to allow the user to add a sales lead. There may be text “display court dates” that may lead to another window that has court dates displayed, for example. There may be several individual categories of progress through the steps of the client sales/acquisition process, by which the user may display sales information about individual accounts and potential accounts. The categories included in the sales homepage may include, but are not limited to, CPA double opt ins (CPA double option insurance), web leads non-CPA, new sales leads non-web, waiting on paperwork, waiting on remainder of pays, ready to be committed, off the street, commitment review, ready to contract, ready to send lead price docs, contracts sent, re-priced contracts sent, has estoppel appointment, and incomplete contracts back. The user may access a database of sales information, which, depending upon which type of view is selected in the sales homepage, may display a different set of data fields. A category may be selected to display a different cut of the sales database fields. There may be columns that include the number of sales records that fit into a given category that may be viewed directly on this sales homepage. The columns may include “total” as one column and “NWT” as another column, by way of non-limiting example only. And each individual number that corresponds to a category row, such as CPA double option insurance, and a category column, such as total, may be selected to initiate a screen that contains the individual sales records and the related data for that sales record.

Still referring to FIG. 1, there is shown a Queue Group pull-down menu 130 in the sales homepage. The Queue Group pull-down menu 130 may allow the user to view sales records according to a desired data category. The Queue Group pull-down menu 130 may lead to different screens that may display other related pieces of data or other fields or other information related to the clients, customers, the clients' clients, or the clients' employees. Items listed in the pull down menu for queue group may include, but are not limited to, sales highlights, marketing queues, sales queues, underwriting queues, legal queues, funding queues, amendment queues, and dead queues.

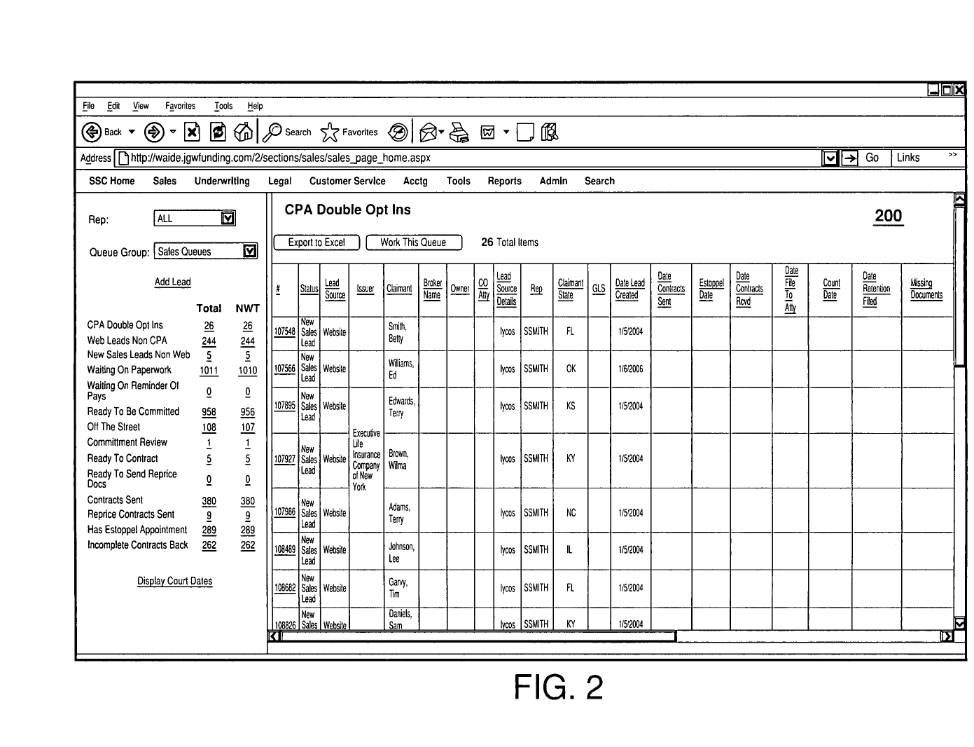

Referring now to FIG. 2, there is shown a “CPA Double Option Insurance” data table 200. When one of the sales category numbers may be selected, for example CPA double option insurance, a separate screen may be presented with individual pieces of data related to individual potential sales accounts or other accounts. This screen may include buttons for “export to excel” and “work this queue.” This screen may list the total number of sales record items. There may be a table or spread sheet that includes numerous data categories, including, but not limited to, record number, status, lead source, issuer, claimant, broker name, owner, CO attorney, lead source details, representative, claimant state, GLS (governing law state), date lead created, date contract sent, estoppel date, date contracts received, date filed to attorney, court date, date petition filed, and missing documents. Each row in the table may represent a separate sales lead or customer. The record number may be selected to lead to a new page with more information and/or more data with respect to the record number. Also, any of the pieces of data may be selected to go to a more specific piece of information. There may be scroll bars with elevators which allow the user to scroll horizontally or vertically to view additional pieces of data that extend beyond the viewing screen. From the sales homepage, by scrolling, a user may access additional information without leaving the sales homepage.

A “Waiting On Paperwork” data table may be selected by a sales employee if it is desired to take actions to receive paperwork from certain clients, to expedite the assignment of a structured settlement. A user may select the “waiting on paperwork” category from the sales homepage, and the categories from FIG. 2 may be displayed. Records corresponding to “waiting on paperwork” may be represented in the rows. The columns may be the same as in the other sales categories with some additions or some omissions. The order of the columns may change, as compared to those shown in FIG. 2, depending on which category is selected by the user.

A “Ready To Be Committed” data table may be viewable to the user upon selecting a number next to the “ready to be commifted” category in the sales homepage shown in FIG. 2. There may be similar categories of data with new rows representing new records which may be sales records. There may new categories which may include “date document sent” and “document”. These two new categories may allow a sales employee to focus on obtaining a client's signature on certain documents in order to expedite the client's commitment process.

There is also a screen that is viewable to the user when “display court dates” is selected in the sales homepage of FIG. 1. This screen may allow a sales employee to view the court dates associated with a particular sales category, such that a new court date may be scheduled that avoids conflict. A new table window may be presented to the user, which includes a plurality of court dates related to a specific sales record or a specific category of data or any way that the user decides to select data to view court dates. The categories displayed in a table may include, but are not limited to, court date, court time, attorney start date, attorney end date, and state. There may be a plurality of rows, each of which corresponds to a particular court date, and each row may include the corresponding pieces of data to the categories mentioned above.

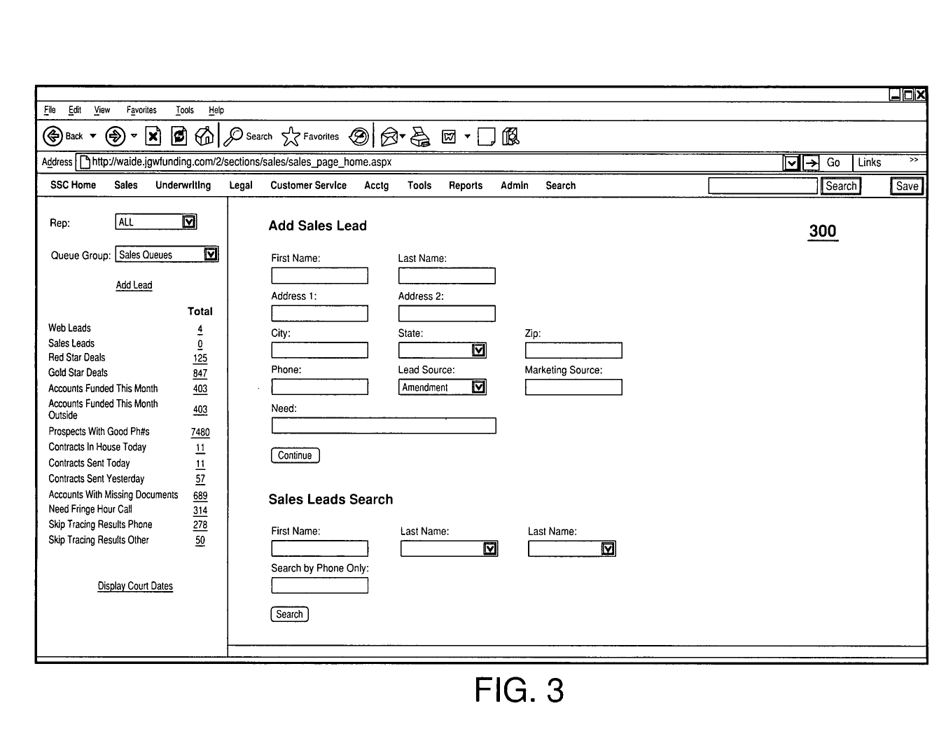

Referring now to FIG. 3, there is shown a Sales Highlights page 300 accessible through the Queue Group pull-down menu 130 on the sales homepage of FIG. 1. The “sales highlights” queue group may display sales data that may allow a sales employee to quickly evaluate how efficiently the sales department is operating at a given time. A user may view a page entitled “sales highlights” selected from the Queue Group pull-down menu 130. As may be seen in FIG. 3, a set of data categories may be selectable by the user to display a set of data from the “sales queues” selection in the queue group. The categories of data in the sales highlights page may include, but is not limited to, web leads, sales leads, red star deals, gold star deals, accounts funded this month, accounts funded this month outside, prospects with good phone numbers, contracts in-house today, contracts sent today, contracts sent yesterday, accounts with missing documents, need fringe hour call, skip tracing results phone, skip tracing results other. As in FIG. 1, the user may be able to view the number of records corresponding to each of the viewable categories. The user may be able to select the number corresponding to the number of records in each category in order to view specific pieces of data or records related to that category.

A “Web Leads” data table may allow a user to view and/or edit a group of client records that were established by client contact through the company web site or internet advertisement. A user may access this screen by selecting the number next to the web leads category shown in FIG. 3. User-selectable buttons may be similar to those shown in FIG. 2. Such buttons may include “export to excel” and “work this queue,” which may allow the user to export the displayed data table to excel. A “work this queue” button may take the user to another screen and presents data entry options to the user to add more information or comments about particular records. A table may be displayed which may include categories such as number, date lead created, form type, first name, and last name. There may be an option for the user to navigate between screens containing tables including certain records. Various limitations may result in only a certain number of records being viewable by the user at a given time. As an alternative to scrolling to view additional records, a user may be able to select and move from one table page to another in ways including, but not limited to, a pull-down menu that allows the user to select a particular page of data to view, and a selectable arrow that advances the user forward or reverse by one page, or other selectable icons which may advance the user's view to the beginning or end of the series of table views.

A “Sales Leads” data table may be accessed by selecting the number next to the sales leads category of FIG. 3. The table may include categories represented in columns, including, but not limited to, number, date lead created, lead source details, form type, first name, last name, company name, phone, email, address line 1, address line 2, city, state, and zip code. Individual records may be shown with pieces of data corresponding to each of the categories referred to above.

A “Prospects With Good Phone Numbers” data table may allow a user to contact potential new clients that may have already provided valid contact phone numbers to the company. This table may be similar in style to the Sales Leads data table. The table may be entitled “prospects with good phone numbers.” The table may be accessed by selecting the number next to “prospects with good phone numbers” of FIG. 3. A data table may be displayed with categories represented in columns similar to those discussed for the Web Leads and Sales Leads tables. Data regarding individual records may be displayed as rows in the table.

An “Accounts With Missing Documents” data table may allow a user to view and/or edit records of clients that may be held up along the process from initial customer acquisition to assignment of a structured settlement, due to incomplete document submission. A user may access this screen from the sales highlights screen of FIG. 3. The “Accounts with Missing Documents” is one of a plurality of categories that a user may access from the “sales highlights” queue group. The columns in a table on this page may be similar to those discussed for the Web Leads and Sales Leads tables. An additional column may be “Broker Company.”

A “Skip Tracing Results Phone” data table may also be accessed from one of the categories in the “sales highlights” queue group from FIG. 3. This screen may be similar in style to the screen described for the Accounts with Missing Documents table, where a table is displayed and categories in the data table may include, but are not limited to, number, claimant name, representative, status, and lead source. There may be rows containing individual records with pieces of data corresponding to the various columns that may be present.

A user may also access a “Marketing Queues” queue group screen. Similar to FIG. 3, this screen may allow sales representatives to select accounts for follow-up that may be in competition with other companies. This screen may be accessible from the pull-down menu in FIG. 1. This screen may display data categories including, but not limited to, representative, queue group, deals with competition, brokers with email, and prospects. Each of these categories may include a total number of records corresponding to each category. Each number may be selected to access more information about that particular category.

A “Brokers With Email” data table may be accessible by selecting a number next to the “brokers with email” category. This screen may allow the user to view a table which may contain data categories including, but not limited to, number, last name, first name, place of business, company name, and email address. The table may include individual rows corresponding to individual records, each of which may contain individual pieces of data. When the user selects an individual piece of data, the user may be presented with an additional screen displaying additional detail about that particular record.

An “Underwriting Queues” queue group screen. This screen may allow an underwriting employee to quickly evaluate the progress of the underwriting department in efficiently handling initiation of client loans. This screen may be accessed from the Queue Group pull-down menu 130 in FIG. 1. This screen may display categories of data including, but not limited to, in house/send attorney paperwork, waiting for petition to be filed—JGW, waiting for petition to be filed—seller, waiting for a court date—JGW, waiting for a court date—seller, court date set—JGW, court date set—seller, and judge holding order. Each of these categories may include numbers of records corresponding to each category, and there may be a plurality of columns of such numbers with title headings including, but not limited to, total and NWT. The user may select any of these numbers to access more detail about the particular category.

An “In House/Send Attorney Paperwork” data table may be accessed by selecting the corresponding category in the Underwriting Queues queue group screen. The user may be presented with a table of data with columns including, but not limited to, number, representative, claimant, claimant state, lead source, date lead created, issuer, broker name, owner, CO attorney, governing law state, and date contracts set. This table may include individual rows corresponding to individual records of customers or other types of records. Each record may include pieces of data corresponding to each of the column categories described above. Each piece of data may be selected by the user to access more detailed information about that particular piece of data.

A user may also access a “Legal Queues” queue group screen. This screen may allow a legal department employee to quickly evaluate the progress of the legal department in efficiently obtaining amendment and/or vacating of court orders assigning structured settlements. Similar to FIG. 3, this screen may be accessible from the pull-down menu in FIG. 1. The screen may include data categoriest such as amended orders needed and vacated orders needed. Each of these categories may include a corresponding number of records which may be selected to access more detail about that category.

An “Amended Orders Needed” data table may be accessed by selecting “Amended Orders Needed” on the Legal Queues screen. This screen may include a table with data in rows and columns, including, but not be limited to, number, sequence I.D., representative, claimant, owner, issuer, purchase date, and first payment date due. As discussed with respect to several of the preceding tables, there may be rows displayed in the table with data records corresponding to the category titles above. Each of these records may be selected by the user to access more detail about a specific piece of data.

A “Vacated Orders Needed” data table may be accessed by selecting “Vacated Orders Needed” on the Legal Queues screen. This screen may display a table with data categories including, but not limited to, number, status, claimant, issuer, owner, date lead killed. As with the Amended Orders Needed data table, this table may include individual pieces of data that may be viewed by the user or selected to reveal more detailed information. If all of the data does not fit on one screen visible to the user at the same time, scroll bars, buttons, or pull down menus may be employed to allow the user to move from one set of data to another on the same screen.

A user may also access a “Funding Queues” queue group screen. This screen may allow an accounting employee to quickly evaluate the progress of the accounting department in efficiently handling review of client accounts for approval of funding a client's lump sum payment. Similar to FIG. 3, this screen may accessed via the pull down menu in FIG. 1. This “Funding Queues” screen may display categories of data including, but not limited to, waiting for copy of order, in review for funding, file complete/ready to fund, and on hold. As discussed with respect to prior screens, each of these categories may have a corresponding number of records associated with it that may be selected by the user to access more detail about the corresponding category.

A user may also access an “Amendment Queues” queue group screen. Similar to FIG. 3, this screen may be accessed via the Queue Group pull-down menu 130 discussed in FIG. 1. This screen may display a list of data categories including, but not limited to, web leads non CPA, new sales leads non web, waiting on paperwork, waiting on remainder of pays, ready to be committed, off the street, commitment review, ready to contract, ready to send re-price docs, contracts sent, re-price contracts sent, has estoppel appointment, incomplete contracts back, contracts in house today, contracts sent today, contracts sent yesterday, accounts with missing docs, court dates set—JGW, court dates set—seller, deals with competition, prospects, future prospects, and need fringe hour call. As discussed with respect to prior screens, each of these categories may display the number of associated records and those numbers may be selected by the user to access more detailed information about that particular category. The number of records corresponding to each category may be displayed in multiple columns with headings including total, NWT, and other columns that the user may define.

A user may also access a “Dead Queues” queue group screen. This screen may allow a management employee to quickly access client records that appear to be inappropriate for providing funds. This Dead Queues category may display a screen accessed by selecting “Dead Queues” on the queue group menu shown in FIG. 1. The screen display categories of data may include, but not be limited to, bad lead, JGW cannot do, court order denied, does not have structured settlement, and future prospect.

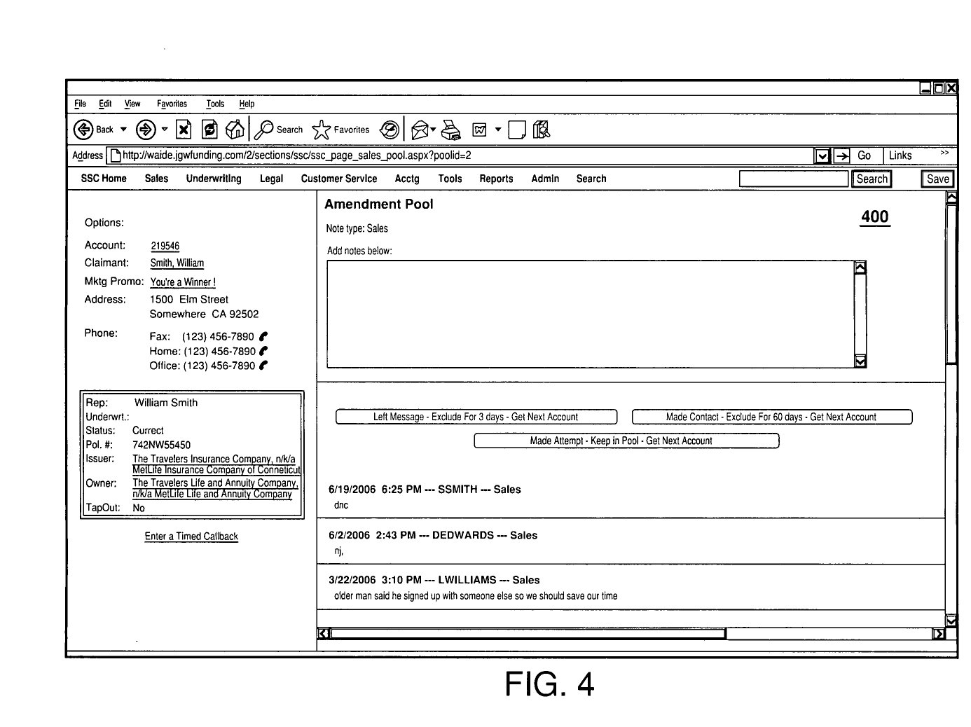

Referring now to FIG. 4, there is shown a screen shot representative of an “Amendment Pool” data viewing and entry screen 400. This screen may be accessed via the Sales menus of FIG. 1, and a Sales Pools sub-menu, which includes an option entitled “Amendment Pool.” This Amendment Pool screen may display a table including categories of data, including, but not limited to, options, account, claimant, marketing promotion, address, phone, representative, underwriter, status, policy number, issuer, owner, tap-out, note type, and add notes below. This screen may provide the ability to add notes to a particular account record or claimant record. For example, there may be a text box for a user to add notes to the record. There may be displayed a plurality of records of data input by prior users including information about each record such as the date, time, user ID, user group, and prior notes. There may be buttons displayed to assist in automating entry of notes and other tasks. Such buttons may include, left message—exclude for three days—get next account, made contact—exclude for sixty days—get next account, made attempt—keep in pool—get next account. Each of these buttons may link to multiple tasks including, but not limited to, an entry of a note that says that the user left a message for the claimant, an action to take this record and make it re-present itself to the amendment pool in three days, and the button may take the user to another account display to then work on that account and type notes into that record.

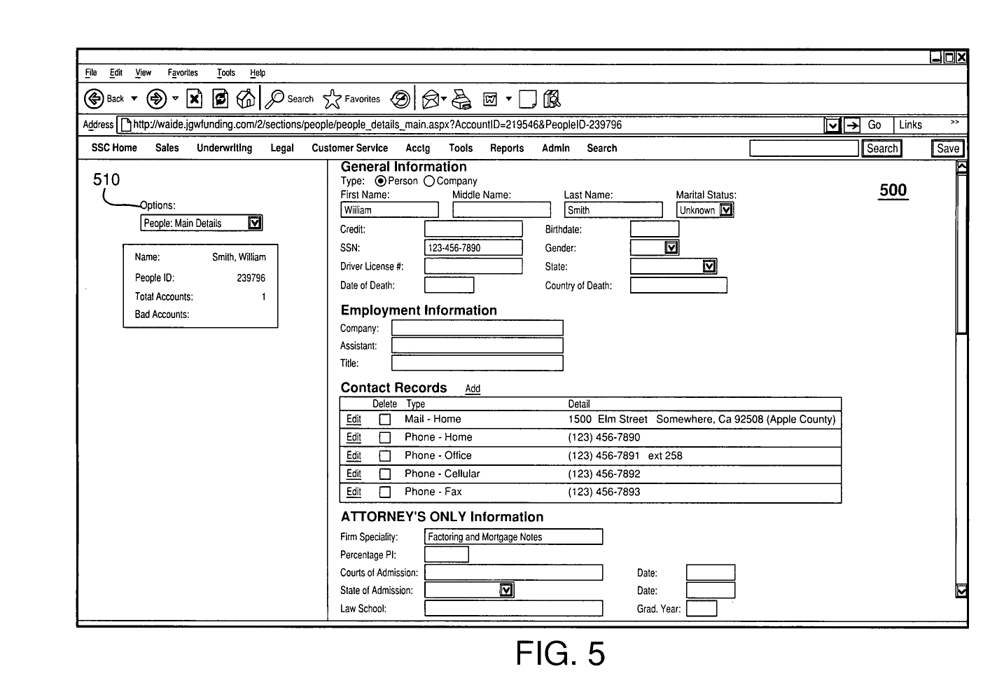

Referring now to FIG. 5, there is shown a screen shot representative of a “People: Main Details” data viewing and entry screen 500. This screen may assist sales personnel in entering data about new clients into the system and viewing/editing these client records. This screen may be accessible by selecting the claimant name visible in FIG. 4. This screen may display the following categories of data, including, but not limited to, general information, type, first name, middle name, last name, marital status, credit, social security number, driver license number, date of death, birth date, gender, state, county of death, employment information, company, assistant, title, and contact records. Within a given category, data may be input into the individual record including, but not limited to, selecting a radio button, typing into a text box, pulling down a pull-down menu, or checking a box which may put a graphic of a check in it. There may be displayed a table including more information about contact records. This table may include categories of information such as delete, type, and detail. The detail category may include information such as a claimant's address and/or phone number, for example. The screen may also include categories of data such as attorneys only information, firm specialty, percentage PI, courts of admission, state of admission, law school, date, and graduation year. Each row of information may be edited or deleted by the user.

FIG. 5 also shows an Options pull-down menu 510. This menu may allow users to quickly toggle between various data fields associated with a particular client. This screen may include a pull-down menu of more screens for the user to access. Options for the user may include, but are not limited to, people account list, people main details, people notes, people roll designations, and people wire info.

A “People: Account List” data table includes information on people contained in the database and may display data categories including, but not limited to, name, people ID, total accounts, bad accounts, account list, account, claimant name, account status, and sales status. There may be an account list table including categories described above such as account, claimant name, account status, and sales status. Each row of data in this table may be a separate record with separate pieces of data; each datum may be selected by the user to obtain more specific information about that piece of data.

A “People: Notes” data viewing and entry screen may allow sales personnel to enter notes from contacts with clients into the system and view prior notes about a particular client. This screen may be similar to the People: Account List screen. This screen may present categories of data input for notes including, but not limited to, new note type, new note text, and filter notes by type. This screen may display prior notes entered into the data record by other system users. The mechanism of entering data into this record may include, but are not limited to, selecting a radio button, selecting in a box, or typing into a text box. This screen may include a button entitled “Hide All Notes,” which when selected may cause prior system users' input notes to be hidden. This screen may be accessed by the pull-down menu in FIG. 5 and selecting “People Notes.”

A “People: Role Designations” data viewing and entry screen may include a table with columns entitled Role Name and Is this Person Already in the Role. The role name categories may include, but are not limited to, broker, claimant, court order attorney, document retriever, estoppel attorney, issuer, owner, and trustee. There may be presented to the user selectable check boxes that direct the record whether or not the person is already in this role. This may be a way to assign a role to a particular claimant, or employee, or other type of record. This screen may be accessed via the pull down menu in FIG. 5.

A “People: Wire Info” data viewing and entry screen may allow a user to enter a client's bank wiring information to allow for transfer of funds to and from a particular client. This screen may be accessed from the pull-down menu in FIG. 5. This screen may include wiring information about the particular record, displaying data in categories including, but not limited to, requires further credit, ABA bank name, ABA bank city, ABA bank state, ABA number, ACH number, person account name, person account number, person account type, and copy of check in file. Each of these fields may include data entered by other users and may include the ability of the current user to edit or input the information corresponding to the categories.

A “Sales Prospect Pool” data viewing and entry screen may allow a user to enter notes related to contacts with a particular prospective client and view previously entered notes associated with the client. This screen may be accessible via the Sales pull-down menu 112 from FIG. 1. This may present one account or claimant record at a time. This may include all of the categories of data shown in FIG. 4, and may include additional categories of data such as note type and add notes. This screen may allow a user to add notes while working with a particular account or claimant. This screen may serve similar functionality as the Amendment Pool in FIG. 4, but with respect to the Prospect Pool, as opposed to the Amendment Pool.

A “Sales WebLeads Pool” data viewing and entry screen may have the same fields and functionality as the “Prospect Pool” screen. The Web Leads screen may allow the user to enter notes when dealing with a record in the “Web Leads Pool,” and the user may be able to view notes typed in by prior users related to the specific record.

A “New SSC Web Leads” data table. may be accessed via the Sales Web Leads Pool screen. This screen may be entitled “New SSC Web Leads.” There may be many categories of data which may be included in this screen including, but not limited to, accept, reject, bulk reject, transfer to application, date created, last name, first name, phone, address, address line 2, state, zip, e-mail address, fax, and company name. This screen may be accessed via the pull down menu of FIG. 1, specifically the Sales pull-down menu 112.

A “Sales Recently Funded” state selection screen may allow underwriting employees to quickly generate a list of accounts in underwriting and that were recently funded, such that the employee may perform follow-up work with these clients. This screen may be accessed via a pull-down menu, including the Sales pull-down menu 112 in FIG. 1. This screen may allow the user to select a state to view recently funded deals and accounts in underwriting. A state may be selected from a pull-down menu or other mechanism of entering states. There may be a button on this page entitled Search allowing searches to be performed from a particular state such as those that fall into the “recently funded” category.

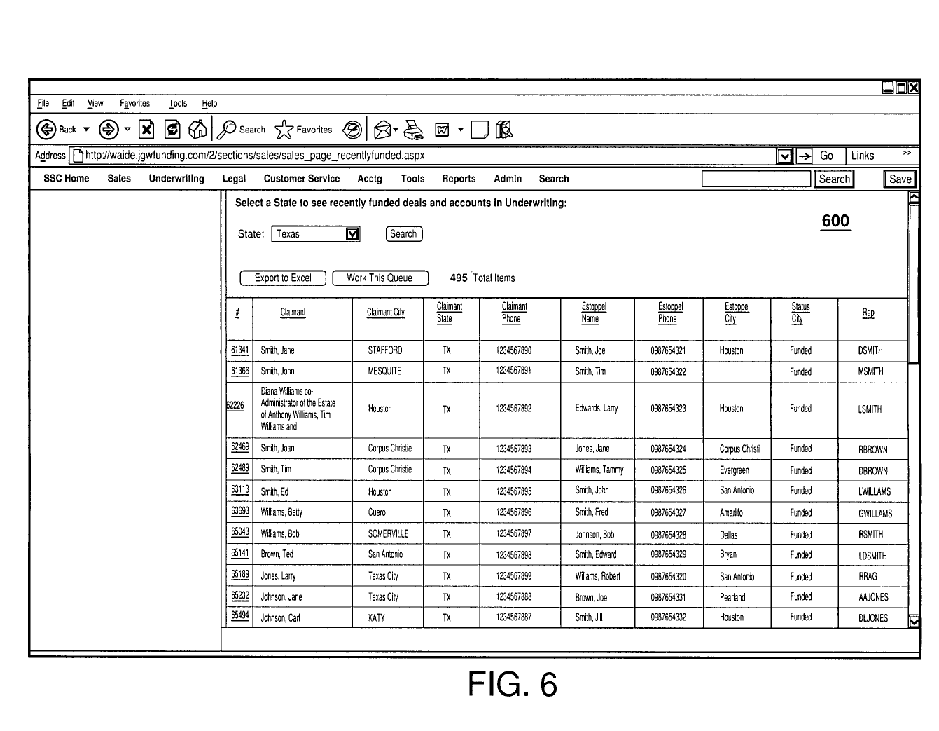

Referring now to FIG. 6, there is shown a screen shot representative of a “Sales Recently Funded” data table 600. A user may access this screen via selecting a state from the pull-down menu at the Sales Recently Funded screen. As may be seen in FIG. 6, when a state is selected, a table of data may be displayed. The table may include categories of data including, but not limited to, number, claimant, claimant's city, claimant's state, claimant's phone, estoppel name, estoppel phone, estoppel city, status, and representative. There may be selectable buttons which allow the user to click to direct the software to export the data to a spreadsheet. This table may include a plurality of rows each of which may correspond to a particular record. Each piece of data may be selected to take the user to more specific data underlying that particular piece of data.

An “Underwriting” pull-down menu may be accessed from the initial screen shown in FIG. 1. This underwriting menu may include, but not be limited to the following options: home, court attorneys, my underwriting accounts, and contract processing. Selecting one of these options may take the user to a screen related to that category.

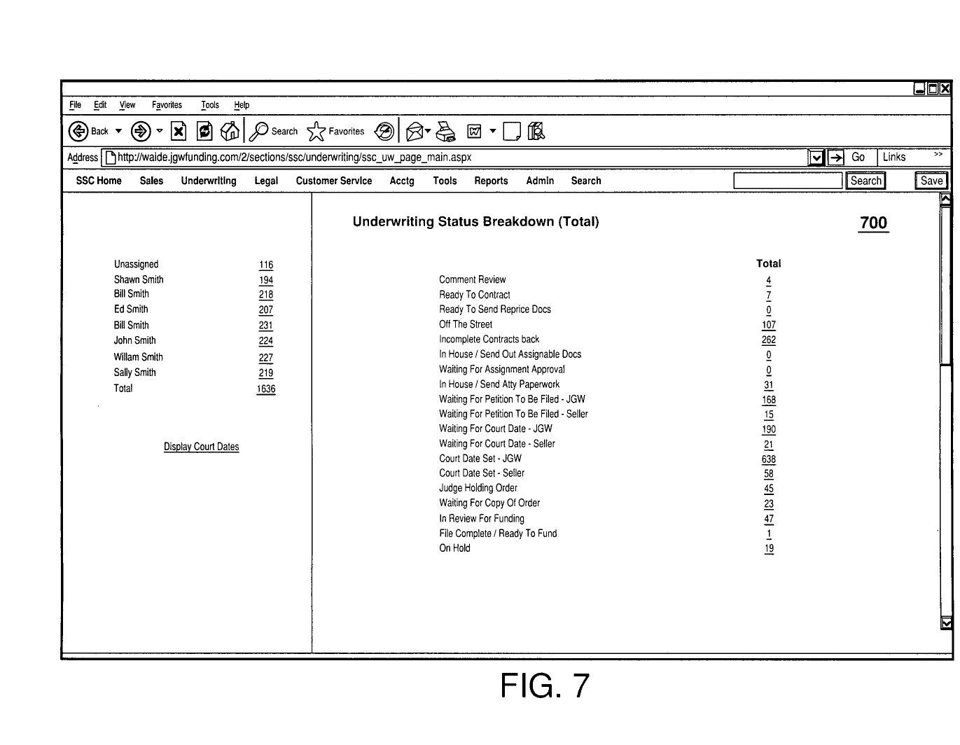

Referring now to FIG. 7, there is shown a screen shot representative of an “Underwriting Status Breakdown (Total)” data table 700. This screen may allow a user to quickly evaluate the work distribution among various underwriting employees. This screen may display a plurality of categories related to underwriting. On one side of the screen may be included individual underwriting employees or other related names. Next to each name may be included a number of records associated with that particular name. There may be a total number of records for each particular employee. There may be a link entitled “Display Court Dates” which may display court dates related to underwriting. On the other side of the screen there may be an underwriting status breakdown. The underwriting status breakdown may be displayed either by an individual employee or by the total of all records. There may be various categories of underwriting which may be accessed by users. The categories of data in this screen may include, but not be limited to, commitment review, ready to contract, ready to send re-price docs, off the street, incomplete contracts back, in house/send out assignable docs, waiting for assignment approval, in house/send attorney paperwork, waiting for petition to be filed—JGW, waiting for petition to be filed—seller, waiting for court date—JGW, waiting for court date—seller, court date set—JGW, court date set—seller, judge holding order, waiting for copy of order, in review for funding, file complete/ready to fund, and on hold. Selecting any of the numbers corresponding to each of these categories may take the user to another screen with more detail about that particular category, as discussed previously.

A “Commitment Review” data table may display the information about particular employees that were available in FIG. 7. The Commitment Review screen may include a data table including categories of information, such as number, representative, claimant, and status time stamp. The table may include a plurality of rows, each of which may have individual data records with individual pieces of data which may be selected by the user to access more detailed information.

A screen shot representative of a “Court Attorneys” data table may allow a user to quickly assess the distribution of accounts between court attorneys and access the individual accounts assigned to a particular attorney. This screen may accessed by selecting “Court Attorneys” in the Underwriting menu shown in FIG. 1. A table including a list of court attorneys and number of accounts corresponding to each attorney may be displayed. The individual numbers of accounts may be selected to view detailed information about the accounts overseen by a particular court attorney.

An “Attorney Cases” data table may display pending client cases of a particular court attorney. Each court attorney may have a table with data in categories in columns including, but not limited to, account, claimant, annuity, courier, and status. Each row may correspond to a particular record and data may be selected to view more detailed information. There may be a link to take the user back to the “Court Attorneys” screen.

An “Underwriting Status Breakdown (My Accounts)” data table may allow a single user to quickly view the workload for which the user is currently responsible. This screen may be accessed through the Underwriting pull-down menu shown in FIG. 1. This screen may display data categories as shown in FIG. 7, with the data categories corresponding to each category that is specific to the user that is requesting the information.

A screen shot representative of a “Contract Processing” process initiation screen may be accessed via the Underwriting pull-down menu shown in FIG. 1. This screen may display the total number of contracts to process and a number corresponding to that. The screen may display a button entitled “Take the Next Available One.” This button may allow the user to begin processing the next available contract for underwriting. Activating this button may take the user to a different screen for entry of data corresponding to a particular record requiring processing.

A “Legal” pull-down menu may be accessible from the main screen in FIG. 1. There may be a menu selection entitled “Legal Queues.” The “Legal Queues” may take the user to a prior figure which displayed the “Legal Queue” information. The “Legal Queue” information is described herein above.

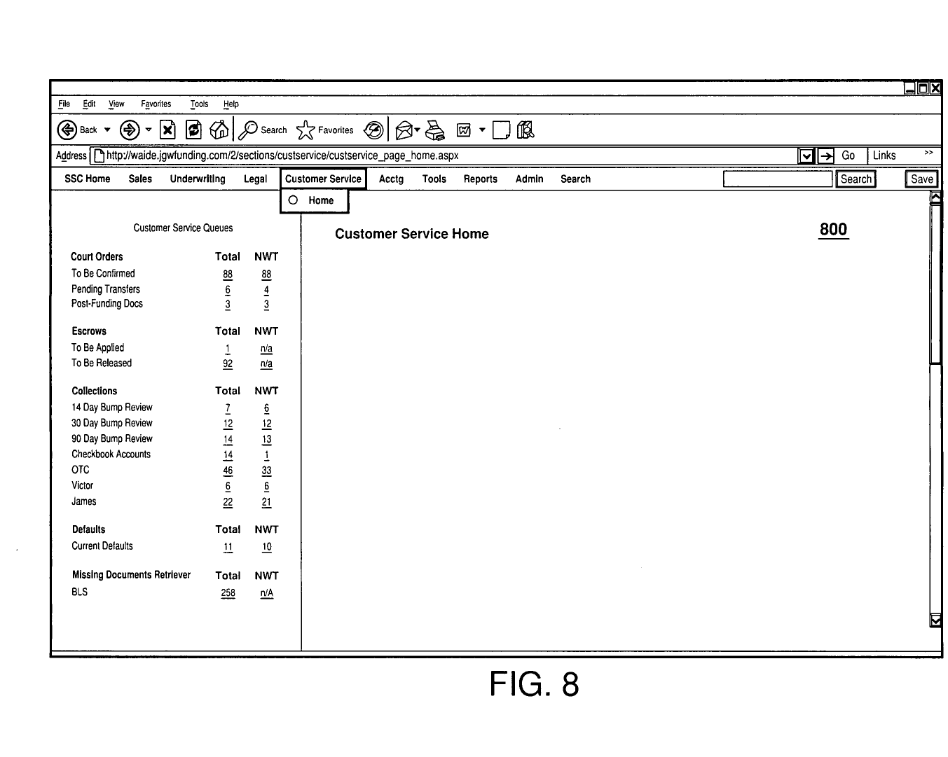

Referring now to FIG. 8, there is shown a screen shot representative of a “Customer Service” pull-down menu and data table. This screen may allow a customer service employee evaluate the distribution of work in the customer service department and choose which category of cases on which to perform additional work. This screen may display a menu selection entitled Home that may take the user to a screen entitled “Customer Service Home” as seen in FIG. 8. This Customer Service pull-down menu may be viewed from the screen of FIG. 1. The Customer Service Home page may take the user to the customer service queues which may contain information and data in the following categories, including, but not limited to, court orders, escrows, collections, defaults, and missing documents retriever. Each of these main categories may have associated sub-categories. The court orders category may include sub categories such as to be confirmed, pending transfers, and post funding docs. The escrows category may include subcategories such as to be applied, and to be released. The collections category may include subcategories such as fourteen day bump review, thirty day bump review, ninety day bump review, check book accounts, OTC, Victor, and James. The defaults category may include a subcategory of current defaults and the missing documents retriever category may include a subcategory of BLS. As in the prior figures, each of these subcategories may include data incorporating a specific number of records associated with each of those subcategories. Each of the record numbers may be presented in a separate column. The columns displayed may include, but are not limited to, total and NWT. As with other figures, if a user selects a particular number, the user may be presented with more specific data related to the particular subcategory.

A “To Be Confirmed” data table may correspond with the “To Be Confirmed heading” in FIG. 8. The user may access this screen by selecting the number next to “To Be Confirmed.” The table of data related to “To Be Confirmed” may display categories including, but not limited to, number, sequence, claimant, issuer, owner, purchase date, policy number, and first payment date due. As with several other figures, there may be a plurality of records displayed in rows visible to the user. Each piece of data may be selected by the user to access more detailed information. Buttons may be provided in order to export to a spreadsheet and to work this queue.

A “Pending Transfers” data table may be accessed by selecting the number next to the “pending transfer” subcategory in FIG. 8. This “pending transfers” page may display the information that was available in FIG. 8 and may contain a table of data related to pending transfers. The categories in the table may include, but are not limited to, number, policy number, claimant, claimant address, claimant city, claimant state, claimant zip, issuer, and owner.

An “Escrows Released” data table may depict escrows released and present such information to a user. This screen may be accessible by selecting a number next to the “To Be Released” subcategory in FIG. 8. This screen may be similar to and may include data categories that include: number, first name, last name, status. This screen may include the number of total records that are listed in the table.

A “14 Day Bump Review” data table may be accessed by selecting “Fourteen Day Bump Review” in FIG. 8. This screen may be similar to the To Be Confirmed, Pending Transfers, and Escrows Released screens. The categories of data presented to the user may include, but are not limited to, number, issuer, and claimant.

A “BLS” data table may be accessed by selecting the number next to “BLS” in FIG. 8. This screen may be similar to the previously licensed Customer Service screens. This screen may present to the user a table of data with data categories, including, but not limited to, number, claimant name, annuity name, owner name, status, court date, and missing documents.

An “Accounting” pull-down menu may be accessed via FIG. 1. This “accounting menu” may display a list of menu selections. The selections may include, but are not limited to, payment posting, unaffiliated payments register, positive pay, cash reports, cash lockbox, wire report, and transfer to MAS90. Selecting these menu selections may take the user to the relevant screen with that title.

An “SSC Payment Posting” data viewing and entry screen may allow an accounting employee to quickly view payments that have posted to the company on a particular day. This screen may display a list of payments. There may be a table with categories including, user, lockbox and total. Each row of this table may include a specific payment regarding a specific user in a specific lockbox. This screen may contain a total of related payments. This screen may allow the user to create a new batch, and the user may pick from a variety of lockbox categories and numbers. Once a user may select a lockbox type and number, a button entitled continue may be present to allow the user to input more information related to additional payment postings. This screen may display the following links, including, but not limited to, run cash report, run passbacks report, approve cash report, and reverse payment. Each of these links may take the user to a specific screen related to those titles.

A user may access a “Batch Details” data viewing and entry screen by selecting the word “select” on any one of the rows of the SSC Payment Posting screen. The user may be presented with a table such as Batch Information, for example. This table may include the following information about batches, including, but not limited to, batch I.D., lock box, user, posting date, total. This screen may display a table containing the following categories of data, including, but not limited to, payment I.D., payment sequence, amount, applied to, payment, applied as, and details. This screen may include links such as delete batch, add payment, and back to payments posting main. The user may select the word “details” in the data table to be directed to an additional screen describing details about a particular payment.

A “Payment Details” data table may display identification about individual payments in a particular batch. There may be a table of information entitled “Payment Information” which may display data categories, including, but not limited to, payment I.D., payment sequence, payment amount, payment, applied as, and claimant. This screen may include a table with the following data categories; amount, type, account, sequence, payment number, and date due. Each row in this table may include individual payments that may comprise the related batch in the Batch Details screen. This screen may include another table with the following data categories, batch I.D., lock box, posting date. This page may display the following links, including, but not limited to, delete payment, back to payments posting main, back to batch details.

An “Unaffiliated Payments Register” data table depicts a listing of payments that were unable to be affiliated with a set account. This screen may be accessible via the Accounting menu shown in FIG. 1. This screen may display data in a table with categories including payment I.D., payment method, date, amount, type, and posted by. This screen may allow the user to select date ranges for unaffiliated payments. The screen may include a button entitled search to initiate the process of searching the database for the requested unaffiliated payments. Each line of data in the table represented in a row may include a separate payment I.D. and the related data.

A “Positive Pay” process initiation screen may be accessed via the Accounting menu in FIG. 1. The positive pay screen may include a link entitled “Process.”

An “SSC Cash Reports” report generation screen may be accessed via the Accounting menu shown in FIG. 1. The SSC Cash Reports menu may include a mechanism for a user to generate cash reports. The user may be presented with a choice of types of cash reports including, but not limited to, cash report, cash report secure sort, pass backs report, cash summary report, and Deutsche Bank transfer report. Other selections for the user may include choose part, which may include a pull down menu by which the user may choose a part. Also included may be “posting date,” with an area for the user to type in the posting date. The user may be presented with at least two links including “run the report” and “export to excel.” This may allow the user to run cash reports and/or manipulate data in the spreadsheet.

A “Cash Lockbox” report generation screen may be accessible via the accounting menu shown in FIG. 1. This screen may allow a user to select a lock box from a list and to type in a posting date. There may be areas where a user may enter or view batch numbers, batch dates, total items, and total amounts. There may be links that allow a user to perform the following, run against today's payment posting, export to excel, print current, or print today's file. All of these options may be found in a table entitled “lockbox main page.”

A “Wire Report” report generation screen may be accessible via the accounting menu shown in FIG. 1. This screen may allow a user to run a wire report or generate a wire report. There may be a place for a user to type in a wire report date. There may be links which may allow the user to run two different types of wire reports. These types of reports may be entitled no further credit, and further credit required. If the user selects either of these links, a report may be generated and delivered to the user via another screen.

A “Transfer MAS90 Files” process initiation screen may allow a user to transfer certain files. The screen may allow a user to type in a transaction date, and a user may select a type of transaction including pass backs or disbursements. The user may select disbursement criteria, including all transactions, transactions not sent to MAS90. After inputting information into this screen, the user may select a link that says “create MAS90 files.” This may allow the user to create MAS 90 transfer files for a particular transaction date.

A “Tools” pull-down menu may be accessible from FIG. 1. The tools menu may include the following sub-categories: sales links, process return mail, extension list, and preferences.

A “Sales Links” internet link table may be accessible via the Tools pull-down menu discussed above. This screen presents a user with external sales links. The Sales Links available to the user may be presented in a table which may include, but are not limited to, area code, exchange finder, Fedex, Mapquest, notary, search, SSC, White Pages, Y (Yahoo Yellow Pages), zip code lookup, my SSC accounts, and new account. This screen may include functionality for the user to add links to the table, delete individual links from the table, or cancel an addition or deletion to the table. From this screen, a user may select an individual sales link and be taken to another page or another website with the desired information.

A “Process Return Mail” process initiation screen may allow returned mail and inventory such returned mail with the appropriate account. This screen may be accessed via the Tools pull-down menu discussed above. The process return mail may request the user to use the bar code scanner to scan in the contact I.D. from the return mail bar code. The contact record may be marked as bad address, for example. The user may be presented with a field in which to type the contact I.D., and the user may be presented with a button entitled make bad address if there is no appropriate bar code to be scanned.

An “Extension List” data table may be accessible via the Tools pull-down menu shown in FIG. 1. The Extension List may include a table of data including phone numbers of appropriate contact people or organizations. The table may display the following categories, including, but not limited to, first name, last name, user name, department, extension, make call, view photo. The make call column may allow a user to select an icon to dial a phone number of a particular contact row. The view photo column may allow a user to select a particular row representing a user or representing a data record and view a photograph related to that record. The extension list page may include the ability of the user to sort the data table by a plurality of categories, including, but not limited to, first name, last name, and department. The screen may inform the user which category the table is currently sorted by.

An “AIDE Preferences” process initiation screen may allow a user to select a color scheme for customization of the colors in the entire system. In an aspect of the present invention, the color selections may include, but are not limited to, black and tan, caramel, cool blue, marbles, patriotic, and racer X. The user may be presented with the ability to choose a style with a pull-down menu or other mechanism of selecting a color scheme. This menu may be accessible via the Tools pull-down menu shown in FIG. 1.

A “Reports” pull-down menu, as shown in FIG. 1, may include the following menu selection items: old AIDE, customer service, legal, management, marketing, sales, and underwriting. Selecting any of these items may cause additional sub-menus to be displayed with additional screen choices for the user to access. The first selection entitled “old AIDE” may take the user to a prior version of the AIDE A “Customer Service” pull-down sub-menu may contain sub-areas for a user to select including, but not limited to, court dates, set report, maturity report, and outstanding payments.

A “Maturity Report” report generation screen may be accessed via the Customer Service pull-down sub-menu. This screen may allow a user to run a maturity report. A user may define a beginning date and an end date in text entry boxes. A user may have the ability to select a link that is entitled “run the report.” If a user selects this link, a maturity report may be generated based on the dates selected, which may take the user to another screen with the desired information.

An “Outstanding Payments Reports” report generation screen may be accessed via the Customer Service pull-down sub-menu. This screen may allow a user to customize outstanding payments reports. The user may be presented with a choice of any of the following reports, including, but not limited to, outstanding payments by due date, by lock box, by pool, by status, or by assignment. The user may be given a field to input a “from” date and a “through” date for the report generation. The user may be presented with a link which, upon selecting, may lead the user to the report. This link may be entitled “Run the Report.” The user may use the reports menu on FIG. 1 to view the sub-categories under the legal option.

A “Legal” pull-down sub-menu from the Reports menu of FIG. 1 may also be accessible. The sub-categories under “legal” may include, court order review, legal aging, legal court dates set, and outside counsel update. Each of these menu sub-selections may take the user to a separate screen that allows the user to pursue additional data related to those sub-categories. Each of these sub-links may allow the user to generate reports based in those areas similar to those seen in the Maturity Reports and Outstanding Payments Reports.

A “Management” pull-down sub-menu may also be accessible from the Reports menu of FIG. 1. The Reports menu may include funding details @065, in-house inventory, and pre-funding balance sheet.

A “Funding Detail @065 Report” report generation screen may allow the user to run an @065 Report and the user may be permitted to input a beginning date and an ending date prior to compiling. The user may be presented with a link that is selectable to run the desired report. The user may be presented with an ability to run a Daily Funding Detail @065 Report. The user may be permitted to choose a term for the report, which may include the selections of month or year.

A “Pre Funding Balance Sheet Report” report generation screen may be accessible through the Management pull-down sub-menu. This may allow the user to run at least two reports, a pre-funding balance sheet report and a pre-funding daily report. There may be links to allow the user to run reports. Selecting these links may take the user to view the actual reports on a separate screen.

A “Marketing” pull-down sub-menu may also be accessed from the Reports menu of FIG. 1. The marketing selection may include sub-selections entitled, marketing promo report and TV marketing call analysis. As was described with respect to previous figures, this may allow the user to run specific reports.

A “Marketing Promo Report” report generation screen may allow the user to run a marketing promo report. The user may choose a marketing program for which to run the report. The marketing programs may include, but not be limited to, All, (all types together), you're a winner, money gram 1, gold card, money gram 2, playoff, star in your own commercial, and you're a winner. The promo report page may include a link upon selecting which may allow the user to run the desired report.

A “Sales” pull-down sub-menu may also be accessible from the Reports menu of FIG. 1, which may include sub-categories of daily lead statust and sales leads related report. Each of these may allow reports to be run related to the selected categories. These reports may be on pages of the website.

A “Daily Lead Status Report” report generation screen inventories new sales leads based on a particular date and makes such leads available to a user. This screen may be accessed through the “Daily Lead Status” selection on the Sale pull-down sub-menu. This screen may allow the user to select a daily lead status details report or a daily lead status by month report. The user may have a link presented to allow the user to initiate the report.

A “Sales Leads Created” report generation screen may allow a sales leads report within the confines of a specific date range to be generated. The various reports the user may run may include, but not be limited to sales leads by status, by lead source, and by representative. The user may be permitted to input a “from” date and a “through” date in text boxes before initiating the report. Upon initiation of run report, the user may be presented with at least two options, one of which may be run the report, and the other which may be export the report to a spreadsheet.

An “Underwriting” pull-down sub-menu may also be accessible from the Reports menu of FIG. 1 which may include the following sub-categories 30K and above spread 065 report, disbursement exceptions, Fed-Ex document tracking, in house inventory, missing docs retriever, remainder of pays, scanned documents, underwriter court order review, and underwriter funded deals and court dates. Selecting any of these selections may allow the user to be taken to a separate screen which may allow the user to run specific underwriting reports.

A “Remainder of Pays Reports” report generation screen may allow the user to run reports either of needs remainder of pays, or remainder of pays evaluation. The report may be selected via a radio button or other mechanisms known to those possessing an ordinary skill in the pertinent art. The user may be presented with a link entitled “Run The Report,” which may allow the user to be taken to a separate screen to view the report.

An “Admin” pull-down menu may be accessible via the initial screen in FIG. 1. The Admin menu may display sub-menu items including, but not limited to, sales, update rates, unfund accounts, IT, tasks, and user management.

A “Sales” pull-down sub-menu may be accessible from the Admin menu shown in FIG. 1. The sales menu selection may have sub-menu items including, but not limited to, groups, sub-groups, tiers, transfer accounts, pool management, and electronic sales person.

A “Sales Groups” data table may be accessed through the “Groups” selection in the Sales sub-menu of the Admin menu. This screen may allow a user to select anyone of a various number of sales reps to view more information related to accounts related to that sales representative. Also, a user may select a link entitled “Add New Group.” This may allow the user to establish new groups of sales reps.

An “Individual Sales Group” data table may be accessible via selection of an individual group of sales reps. A user may be presented with a table of data related to that particular group of sales reps. The groups of sales reps may be displayed on the Individual Sales Group screen. The screen may display the title corresponding to the particular group of sales reps selected. The screen may include the name of the leader of the particular sales group. The screen may include a table which includes data of the information related to each member of the sales group. The table may have data columns including, but not limited to, first name, last name, user name, and sub-group. A user may be able to select a particular row representing a particular sales representative in order to view information in greater detail about that particular sales representative.

A “Sales Tires” data table may be accessed via the Sales sub-menu of the Admin menu shown at FIG. 1. This may display various groups of tiers. The user may select a particular tier to find out more information related to that tier. The user may be presented with the ability to add a new tier.

An “Individual Sales Tier” data table may resemble the Individual Sales Group data table. There may be a table including categories of first name, last name, and user name. There may be rows of data including specific sales people that are members of that tier. There may be fields for input of “goal out” and “goal in.” There may be a button entitled “Edit Goals,” which the user may select to edit goals.

A “Transfer Accounts” process initiation screen may allow a user to transfer accounts from one sales representative to another. A user may select from among the following types of data: from representative, to representative, status, and amount. This may allow a user to designate which sales representative an account is going from and to, the status of the account, and the amount related to the account. There may be a button entitled “Transfer Accounts” which may initiate the transfer in the computer system once all date selections have been completed and the user may wish to transfer the account.

A “Sales Pool Management” data table may be accessed via the Sales sub-menu of the Admin menu shown at FIG. 1. The sales pool management screen may include a set of data in a table with columns that contain data categories which may include the following: pool, last built, account, and exclusions. The individual rows of data in the sales pool management table may include different types of sales pools. Each individual row may include a link that the user may select that is entitled “Rebuild.”

A “Manage Representatives” process initiation screen allows a user to assign confirmed leads to a particular representative. The user may be able to select a link entitled “Manage Representatives.” Once a user selects the manage representatives link, data may be available to the user on a portion of the screen entitled “Manage Representatives.” This portion of the screen may allow reps to be assigned confirmed leads by an electronic sales person. A table may be presented entitled “Hot Reps” which may allow a user to select individual sales representatives to be assigned confirmed leads as opposed to leads that are not confirmed.

An “SSC Settings” data table may be accessed via the Admin menu shown in FIG. 1. This update rate screen may include a table of data entitled “SSC Settings.” A user may be able to select an accretion date in a text box. A user may be able to add federal fund rates via a link. A user may be presented with a table with categories and rows, with column categories including delete, year, month, rate, and prime rate. This may display a user the rates in effect at various years and months in time. There may be links for a user to edit this information, row by row. There may be ways for a user to select individual data items and to delete them.

An “SAC Management” process initiation screen may allow a user to unfund particular accounts. There may be a selection shown to the user where a user may type in a text box an account to be unfunded. There may be a button for the user to select that is entitled “Show Summary.” Selecting this button may display a summary of the transaction unfunding a deal.

An “IT” pull-down sub-menu may be accessed from the Admin menu and may include sub-menu items event logs and help desk.

An “Event Logs” report generation screen may allow users to view log data related to the IT system. A user may be presented with the ability to make selections in the following categories: server, log type, date from, and date to. This may allow a user to specify a period of dates in which to view logs pages at a particular server or servers and of a particular log type or all log types. There may be a button which may allow a user to view the log data that is specified via the user selections on the event logs page.

A “Help Desk—Developer Items” help ticket data screen enables a help desk employee to view items currently in the queue for that or any help desk employee. This screen may be accessed via the IT sub-menu of the Admin Menu shown in FIG. 1. There may be a table for each individual IT developer. Each IT developer may be shown a number of pieces of data including recently completed number and an active item number. The user may be presented with links to select related to the following categories, including, but not limited to, current priority items, stuck waiting on, pending development, lower priority items, and recently completed. Each link in each of these sub-categories may represent a particular help ticket with a particular description of a particular user problem that the developer may need to work on. Selecting any of these links may take the user to a separate screen related to those specific help issues.

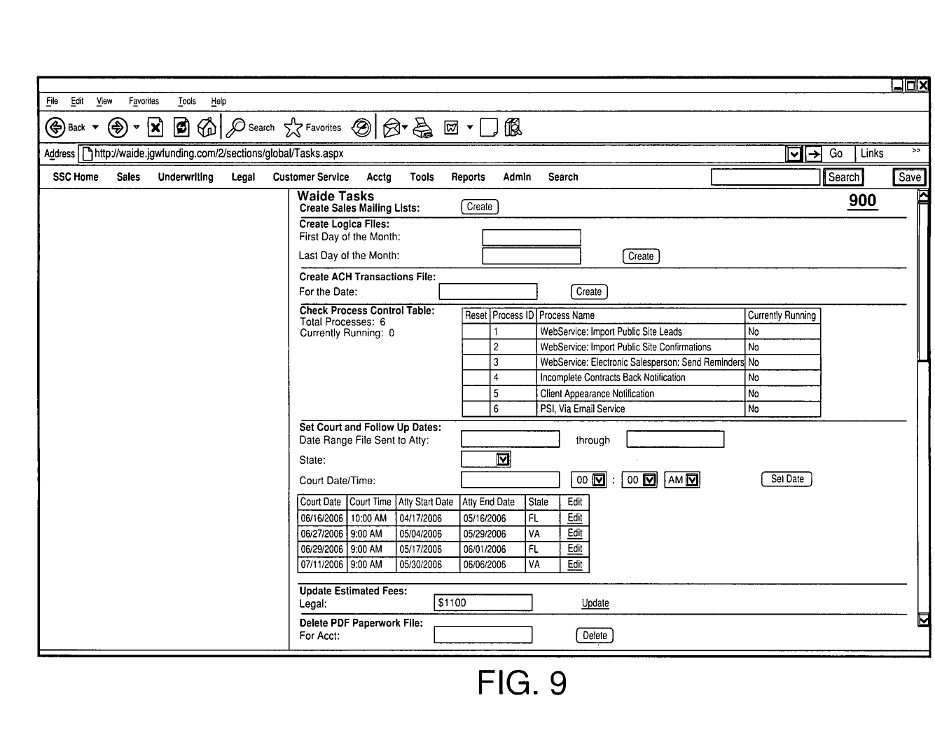

Referring now to FIG. 9, there is shown a screen shot representative of a “AIDE Tasks” data viewing and entry screen 900. This screen may include various ways for a user to perform administrative tasks in the system. As may be seen in FIG. 9, the screen may display user-defined tasks including, but not limited to, Create Sales Mailing Lists, Create Logical Files, Create ACH Transaction File, and Check Process Control Table. There may be displayed buttons for each of the first three tasks, a Create button that may allow a user to create the sales mailing lists, a Create button that may allow a user to create logical files with options where the user may define first and last day of the month for the file, and an option where a user may create an ACH transaction file for a particular user defined date. A check process control table may include a number for the amount of total processes and the amount currently running. The check process control table itself may display column categories including, but not limited to, reset, process ID, process name, and currently running. The table itself may include individual processes and related pieces of data.

There may also be a “Set Court and Follow Up Dates” table” which may display columns headed by data elements including, but not limited to, court date, court time, attorney start date, attorney end date, state, and edit. Each row in the table may include a specific court date on the related data. The last column which may be entitled “Edit” may allow the user to edit the date associated with a particular court date. The “Set Court and Follow Up Date” section may allow a user to set a new court date where the user may define the date range file sent to attorney dates, the state, and the court date and time. There may also be an “Update Estimated Fees” option where a user may put in estimated fees. As may be seen in FIG. 9, a user may delete a PDF paperwork file for a specified account number. The user may have access to a delete button that may be selected to delete a paperwork file.

An “AIDE Management Pages” pull-down menu screen may be accessed via the Admin menu shown in FIG. 1 The AIDE Management Pages may allow a user to set the ability of various users to access different parts of the AIDE computer system, and a system administrator may be able to assign users to various groups, contents to various groups, and various other functionalities. An administrator may have links available to add a user, add a user group, add a content group, list active users, and list disabled users. A link may be available to return to the management menu. A user may use pull-down menus in each of several categories to select individual items. The categories may include, but are not limited to, user, user group, content, content group, other user groups, and other content groups.

A “User Info” data viewing and entry screen may include user info, which may include a login name, actual name, and a link to view user details. The screen may display which groups a user belongs to and which groups a user does not belong to. The administrator may be able to set which groups a user may or may not access through selecting in a box and placing a check there. The groups listed may be selected by the user to access screens related to those groups.

A “User Details” data viewing and entry screen may allow an administrator to enter various types of information about an individual or a group. This may include any of the following types of information, including, but not limited to, user type, user ID, first name, middle name, last name, status, title, phone extension, department, start date, end date, network ID, CT ID, security card ID, benefits start date, and, can the user be a representative on an account. A user may use a different user profile as a template for this particular new user that the administrator may want to define in the text boxes. There may be a pull down menu which may allow a user to choose another user as a template. There may be a link for copy settings to allow such a template to be used. There may be links to security settings.

A “User Group Management” data viewing and entry screen may give the administrator the ability to display a social security number and assign that ability to a particular group. It may allow a user to define which group has access to which content screens.

A content pull-down menu of the AIDE Management Pages may display every page available in the AIDE system. If one of these items may be selected, the user may be taken to a separate page to decide which groups and users may use this particular page of content, and which groups or users may not access it.

A “Content Info” data viewing and entry screen may also be available. If a particular content page is selected, various pieces of data may be available to the user. These pieces of data may include content information which may include “Name” and a link to the particular page. The page may be a member of content groups which may be shown on this page. Also the user may view which content groups the page may not be a member of.

For a particular content page, an administrator may define which users have access to that page through check boxes next to individual I.D.'s, and which users may not have access to that content. An administrator may also select which user groups may have access to a particular content page, and which user groups may not have access to a particular content page. Each particular page by being selected may bring up these content management options by which an administrator may determine which users and which user groups may be allowed to access particular pages.

A “Content Group” pull-down menu may also be accessed from the AIDE Management Pages. This menu may allow an administrator to select a content group, and that selection may take the user to a new screen which may allow groups of content pages to be assigned for access of individuals, or access of groups, or not be accessed by individuals or certain groups.

A “Content Group Info” data viewing and entry screen may be accessed. If an individual content group is selected from the Content Group menu. A screen may be presented to an administrator that contains the name of the content group as well as which pages may be in the content group. The pages in the content group may be assigned either to be in the group or not in the group via this “Content Group Management” page. Also, users and groups may be assigned to have access to this particular content group or not to have access to this particular content group.

A user may select the “Search” menu from the group of menus shown in FIG. 1. The search menu items may include, but are not limited to, People Search, Account Search, and SSC Search. Selecting any of these options may take a user to a screen where the user may perform those particular types of searches.

Searches may be performed via the People Search” search initiation screen to quickly access particular records. The user may be prompted to enter various search criteria in text boxes. Such data to be entered by the user may include, but not be limited to, people ID, first name, last name, company name, social security number, email address, address, city, state, zip, and search by phone only. This screen may contain a button entitled “Search,” by which a user may begin a search after typing criteria to be searched for in one or more of the search text boxes.

Search criteria that may be entered at an “SSC Account Search” search initiation screen by a user may include one or more of the following, including, but not limited to, first name, last name, social security number, policy number, issuer, access ID, state, and search by phone only. There may also be a search button. Also, there may be a pull-down menu instead of, or in addition to, text entry boxes for the user to select the search criteria.

An “SSC Account Search” pull-down menu may allow the user to search by any of various selections in a pull-down menu. The pull-down menu may contain items to be searched by, including, but not limited to, claimant, claimant's social security number, policy number, and issuer. Alternatively, a user may enter in a text box what field to search by. There may also be a search button.

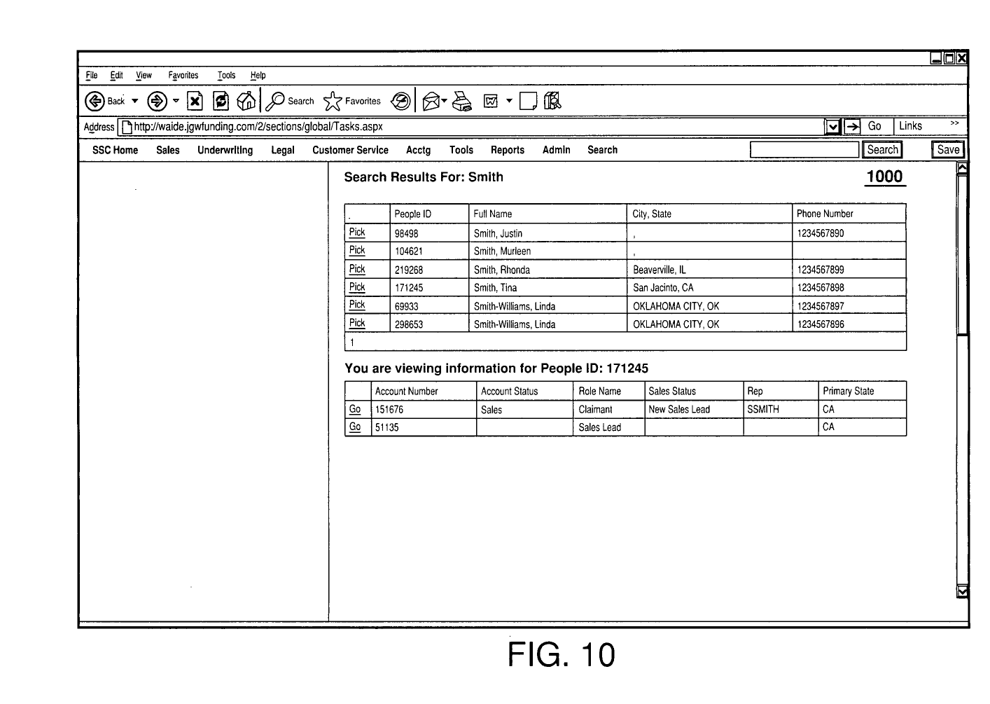

Referring now to FIG. 10, there is shown a screen shot representative of a “Search Results” data table 1000. The screen of FIG. 10 is a display of the results of a particular search and enables the user to select from the resulted searches. The text search box in many of the figures along the “menu” strip that is shown in FIG. 1 may be used to search for a particular text string. A user may type in a particular search string, and initiate presentation of a table of data that displays records having a field including the search string. For example, in an aspect of the present invention, a search string that may appear in the full name category may pull up column data such as, people ID, city, state, and phone number. Such a table displaying the various records with that search string may include links that may allow a user to choose one of the records for further investigation. If one of those rows may be selected by the user, the screen may display more details about that particular record. More details included may include, but not be limited to, account number, account status, role name, sales status, representative, and primary state. Also in the table for a particular search string may be included, links for each row that are entitled “go” which may allow the user to then open a particular account in the system and go to a window that may have details about the data in that particular account.

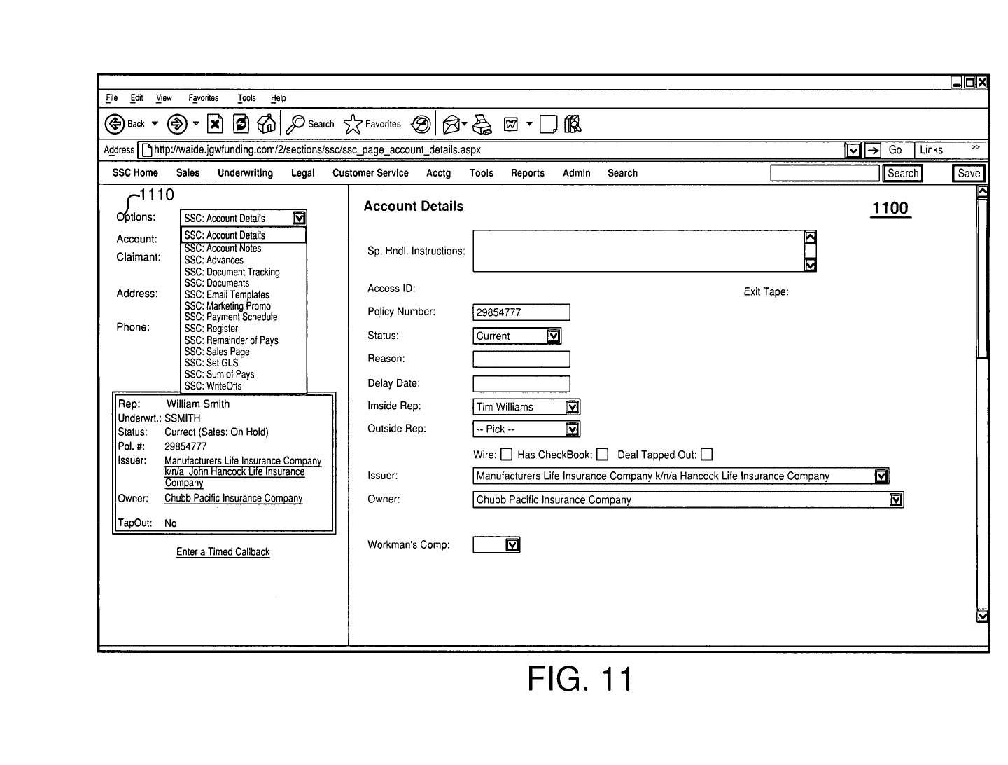

Referring now to FIG. 11, a screen shot representative of an “SSC: Account Details” pull-down menu. One way to access the account details screen is via the “go” selection in FIG. 10 for a particular account number. There may be numerous other ways to access this screen via the other figures discussed above. As may be seen in FIG. 11, the main account details screen may include an “Options” pull-down menu 1110 which may take the user to details related to accounts. The various options may include, but are not limited to, account details, account notes, advances, document tracking, documents, email templates, marketing promo, payment schedule, register, remainder of pays, sales page, set GLS (Governing Law State), sum of pays, and write-offs. As may be seen in FIG. 11, the “account details” pull-down option may display the user an “Account Details” screen with various details displayed. Certain information about an account may be visible to the user in any of the options that are pulled down in the Options menu. Such categories may include, but are not limited to, account, claimant, marketing promotion, address, phone, representative, underwriter, status, policy number, issuer, owner, and tap out. There may be a selection by which the user may enter a timed call back for a particular account.

The “SSC Account Details” data viewing and entry screen shown in FIG. 11 may include the following data which may be entered by a user, including, but not limited to, special handling instructions, access I.D., exit tape, policy number, status, reason, delay date, inside representative, outside representative, issuer, owner, workmen's comp, wire, has checkbook, and deal tapped out. These various details may be input by the user via a text box, a pull down menu, a check box, a radio button, or any other mechanisms known to those possessing an ordinary skill in the pertinent art.

An “SSC Account Notes” data viewing and entry screen may be accessed via the Options menu shown in FIG. 11. This screen may allow a user to input notes linked to a specific account. This may include any number of the following categories of data, including, but not limited to, note type, notes, note filtering. The user may choose a note type from a list of pre-defined types, the user may add typewritten notes to the record of the account, and the user may view notes entered by other people. The user may filter notes entered by other users by any of several categories. There may be a selection by which the user may hide all of the notes when looking at this screen.

A “Payment Schedule Advances” data table may also be accessed via the Options pull-down menu in FIG. 11. Payment schedule advances may present data about a particular account including, but not limited to, the following categories, advances, transaction, invoice, date due, date received, amount due, and amount received. The table that may be displayed may include a row for each of the many transactions. Each transaction may be selected for editing via a check box by the user.

A “Document Tracking” data table may also be accessed via the Options menu in FIG. 11. Document tracking may present to the user a table with various columns of categories of data regarding particular documents. Such categories of data may include, but not be limited to, the following, tracking number, carrier, document, sequence, generated, cancelled, edit, and cancel package. There may be in this table one row for each document. The tracking number may have links which may allow a user to go directly to a document courier website, for example, Federal Express. Such a tracking number link may give the user automatic information related to the status of where the package is located in the delivery system. There may be an “edit” link for each series of data representing a document which may allow the user to update information. There may be links for each row to allow the user to cancel the tracking of a particular document in the system. There may be a button entitled “Add Tracking Info,” which may allow the user to add new rows of data for new documents to be tracked in this page.

An “SSC: Documents” data table may also be accessed via the Options menu in FIG. 11. The document screen may display the user documents related to a particular account. A table may be shown to the user with the following categories of data, including, but not limited to, file name, document, file size, created, email, edit, and delete. The table may have one row for each particular document related to an account. There may be a link for each row/document to view the document itself. There may be links for each document such as, email, edit and delete, which may perform those functions on the particular document. There may be a link that is entitled “View Paperwork.” There may be a button entitled “Upload New Document,” which may allow a user to include new documents in the system attached to a particular account number.

An “Email Templates” pull-down menu-may utilize the software via this screen to automate various types of customer correspondence including email. This screen may also be accessed via the Options menu in FIG. 11. The E-mail Template screen may present to the user a choice of which type of e-mail to send from a various number of choices defined by the system administrator or user. This screen may display a text box in which to type an e-mail address to send the e-mail template to.

A “Marketing Promo” process initiation screen may also be accessed via the Options pull-down menu in FIG. 11. The marketing promotion screen may allow a user to award a marketing promotion to a particular person associated with the account that may be linked to this screen. Such account may be able to be seen on one part of the screen which may contain the same information that may have been available to the user in FIG. 11 and its related Options screens. The marketing promotion screen may include the following data fields to be entered, including, but not limited to, program name, program begin date, program end date, prize one, date prize claimed, and date prize shipped. There may be a button for the user to select entitled claim prize, which may begin a process in the computer system of shipping a prize to the particular claimant linked to the account.

A “Payment Schedule” data table provides a user access to a payment schedule for a given account. The Payment Schedule screen may also be accessed via the Options menu in FIG. 11. The payment schedule may be linked to an account shown on the same screen. The data for a payment schedule may be presented in a table, and the data categories may include, but not be limited to, ADV (advance), sequence, invoice, amount due, date due, amount received, date received, source, secure, and status. There may be one row for each particular payment that is due related to this account that is shown on the screen. Also, the user may be able to select an individual payment row in order to obtain more data or in order to perform a function on that particular payment.

A “Payments Register” data table may also be accessed via the Options menu shown in FIG. 11. Payment Register may display data categories including, but not limited to, payment I.D., transaction I.D., print method, date, sequence, invoice, amount, type, and posted by.

A “Remainder of Pays” data table may also be accessed via the Options menu shown in FIG. 11. The Remainder of Pays screen may include a table with data in categories including, but not limited to, date due, total available, amount purchased, and amount left to purchase. There may be one row of data for each payment remaining. There may be buttons for the user to select including, import annuity, view diffs. This may allow the user to perform functions on this data set which may include adding more annuities to the remainder of pays payable, or viewing differences between perhaps for example amount purchased total available or amount left to purchase.

A “Sales Page” process generation screen may also be accessible via the options menu in FIG. 11. The Sales Page may include the ability to enter sales data related to a particular account and claimant. The areas in which a user may define data fields may include, but not be limited to, lead source, marketing source, gold star deal, need, and needs a fringe hour call. These categories of data may be input by the user via textbox, pull down menu, radio button, check box, or any other mechanisms known to those possessing an ordinary skill in the art. Also accessible from this page may be other links which perform various functions on sales data, including, but not limited to, generate contract, generate re-price contract, generate missing docs, generate submission check list, generate off the street letter, generate court orders, generate AG package, and generate petitions/order.

The Sales Page may contain a pull-down menu by which the user may select a lead source. The lead source may be any of several types, including, but not limited to, add call, amendment, APP, APP TV, APP web, APP wholesale, attorney, broker, friends and family, insurance company, old prospect, portfolio, radio, TV, UCC, and website.

A “Pick a GLS” (Governing Law State) data entry screen may be accessible via the Options menu shown in FIG. 11. This screen may allow a user to select a governing law state attached to a particular account and/or claimant. This screen may tell the user what the current governing law state may be.

A “Sum of Pays” data table, may also be accessed and may include data in a tabular form, with categories including, but not limited to, year, month, and total purchased for a month. Each row may represent a particular month's payment. There may be many rows of data related to many payments for this particular account and/or claimant.

A “Payment Schedule—WriteOffs” data table may be accessible via the Options menu shown in FIG. 11. A listing of write-off amounts may be displayed for review. The screen may include a data table, including categories, including, but not limited to, check, transaction, invoice, date due, date received, amount due, amount received, and date written off. The data table may include a line of data for each particular payment that may be written off. There may be a way for the user to select one or more rows of data representing one or more payments. There may be a button which may allow a user to write off one or more payments. There may be a button to clear all the check boxes for each particular payment so they may not be written off. There may be a choice by which a user may choose transactions for write off, to either select them or deselect them.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

In addition to the foregoing, the present invention also offers additional capabilities. These include a Court Research Queue which allows the user to search court dockets to learn of new filings and the details pertaining thereto and further permits the user to ascertain the status of cases previously filed. The present invention also may contain a Work This Queue functionality which allows the user to obtain a list of matters that should be worked on at a particular time. The user may also use the present invention to manage life contingent payments. For example, the user may keep track of payments made and upcoming payments along with the date of birth and/or death of the interested party. The user may further utilize the present invention to enter information pertaining to annuities, such as the payment amount, payment date, person to whom payment is made, address where payment is sent, and other pertinent information necessary to track and manage annuities. The present invention also provides the user with email templates which can be selected from a variety of pre-formatted and pre-populated forms which can be modified and can then be e-mailed to an address or addresses which can be accessed from a directory via use of the present invention. The user is also able to email other information, for example, the screens discussed previously, to a desired recipient. The user may also utilize the present invention to generate contracts. Form language may be obtained from a contract database which can then be altered to suit a particular need. Such contracts can them be emailed, if so desired, to the desired recipient. The present invention also allows the user to document the date and time a call is placed and schedule a reminder for a follow-up call. The present invention also allows the user to place a call and schedule a time for an additional call if the number is busy or if there was no answer, etc.

The present invention also contains functionality directed toward creating and maintaining an organized office environment. Such functionality includes a link to an employee handbook, which can be searched for specific topics. Additional functionality offered by the present invention allows the user to scan the bar codes for packages being sent out and received. The user can then track the status of the packages to confirm delivery and receipt.

1. A computer software package for managing data related to at least one purchase of at least one future value asset, comprising:
a database, wherein the database comprises data related to at least one account, the account identifying a transaction between a holder of a future value asset and a purchaser of future value assets;
an interface, wherein the interface allows access to the data; and
a generator, wherein the generator produces at least one report of the at least one account, and the report is generated in response to at least one command entered at the interface;
wherein the data comprises information regarding the transaction.

2. The computer software package of claim 1, wherein the future value asset is an annuity.

3. The computer software package of claim 1, wherein the future value asset is a structured settlement.

4. The computer software package of claim 1, wherein the transaction is a potential sale of the future value asset from the holder to the purchaser.

5. The computer software package of claim 1, wherein the transaction is a sale of the future value asset from the holder to the purchaser.

6. The computer software package of claim 1, wherein the future value asset is selected from the group consisting of: life insurance payouts, lawsuit advances, mortgage notes, inheritance advances, lottery payouts, and cell tower lease advances.

7. The computer software package of claim 1, wherein the purchaser is an asset purchase company, and wherein the asset purchase company has a plurality of asset purchase agents, and wherein the database further comprises information related to the plurality of asset purchase agents.

8. The computer software package of claim 7, wherein the database further comprises a correlation between the holder and the asset purchase agent.

9. The computer software package of claim 1, wherein the database further comprises information related to at least one term of the transaction.

10. The computer software package of claim 1, wherein the database further comprises information regarding a plurality of transactions involving a plurality of holders and at least one asset purchase agent.

11. The computer software package of claim 1, wherein the interface allows entry of information regarding a holder.

12. The computer software package of claim 7, wherein the reports are based on queries for a certain asset purchase agent.

13. The computer software package of claim 7, wherein the computer software package further comprises at least one reminder to alert an asset purchase agent of certain stages of a purchasing process.

14. The computer software package of claim 1, wherein the database further comprises underwriting information.

15. The computer software package of claim 3, wherein the database further comprises information related to the holder's involvement with a local court system to enable the purchaser to purchase an outcome of a judicial proceeding.

16. The computer software package of claim 1, wherein the database further comprises information related to an amount of money borrowed by a holder against a value of the future value asset.

17. The computer software package of claim 1, wherein the database further comprises information related to a payment by a holder on a loan related to the future value asset.

18. The computer software package of claim 1, wherein the database further comprises information related to an escrow account of a holder.

19. The computer software package of claim 1, wherein the database further comprises information selected from the group consisting of: information regarding a court system, an insurance company, or a bank related to the future value asset.

20. The computer software package of claim 1, wherein the generator can further produce monetary reports regarding a financial health of the purchaser of future value assets.

21. The computer software package of claim 1, further comprising two or more databases which can be searched simultaneously.

22. The computer software package of claim 1, wherein the interface is secured and requires access through a secure portal.
